(19) United States
(12) Patent Application Publication
(10) Pub. No.: US 2006/0293908 A1
(43) Pub. Date: Dec. 28, 2006

(54) Method for providing customized information to vehicle user

(76) Inventors: Craig H. Becker, Austin, TX (US); Leugim A. Bustelo, Austin, TX (US); Stewart E. Nickolas, Austin, TX (US); Newton J. Smith JR., Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(21) Appl. No.: 11/168,723

(22) Filed: Jun. 28, 2005

(51) Int. Cl. G06Q 99/00

(52) U.S. Cl. 705/1

(57) ABSTRACT

A method of providing customized information to a customer. In an embodiment, the method of providing customized information to a customer such as a car rental customer includes receiving at least one customer preference. Next, data is accessed in accordance with the at least one customer preference. Such data in accordance with the at least one customer preference is written to a storage device which is delivered to the customer. This information may also be provided wirelessly via the Internet so that this information may be up-dated in real time.

### FIELD OF THE INVENTION

The present invention generally relates to the field of information services, and more particularly to a method for providing customized information such as music and news to vehicle users.

### BACKGROUND OF THE INVENTION

Due to the increasing globalization of the economy and lower airfares, air transport is being increasingly relied upon by a greater number of people. Lower airfares affect the demographic profile of the air transport market, for such fares allow individuals with lower incomes in addition to the higher income travelers to travel by air for leisure as well as business purposes. Further, air transport has become essential for world business since air travel allows services and products to be readily transported over long distances in relatively short amounts of time thus providing a conducive atmosphere in which global business transactions may occur.

Not only has the number of travelers increased with the globalization of the economy, but the time that each individual spends traveling has also significantly increased. Again, due to the global economy, a number of individuals (e.g., business people) spend a great deal of time traveling by air to conduct business transactions. With the increase in air travel, comes an increase in the need for access to ground transportation services by travelers upon reaching their destinations.

Often travelers rent cars from car rental companies for transportation while in a destination city. Typically, rental cars include a radio as well as a compact disc (CD) player or cassette player which allow a traveler to listen to music, news, and the like while in transit. Although such features are designed to make the travel time more pleasant, often a traveler finds the features to be cumbersome and frustrating. For example, most cities broadcast news and music from a variety of different entities/stations and a traveler is typically not familiar with the “content” on the various stations. Thus, one spends the majority of time “channel surfacing” and not enjoying the broadcast.

In addition, in order to utilize the CD or cassette player a traveler ordinarily transports the CDs or cassettes with them. Such transport is cumbersome for it requires the traveler to not only remember to pack the CDs or cassettes, but allow for the additional space that such items occupy during transport. Further, it is not desirable to transport CDs or cassettes for they may become damaged while in transit.

An additional concern for travelers once arriving at their destination is the determination of what restaurants, sites, and activities they may wish to access during their stay. Often such information regarding the various types and locations of local restaurants, historical sites, and the like may be found in brochures provided by local hotels. However, such brochures require the traveler to take additional time to read the content contained within the brochures and a traveler may be required to read multiple brochures before finding something of interest. In addition, a traveler often desires such information prior to departing from the rental car company site and therefore, access to such information becomes problematic.

Therefore, it would be desirable to provide a method which would provide custom music, news, restaurant, historical site information, and the like to vehicle users such as rental car customers.

### SUMMARY OF THE INVENTION

In a first aspect of the invention, a method of providing customized information to a customer is disclosed. In the present aspect, the method of providing customized information to a customer such as a car rental customer includes receiving at least one customer preference. Next, data is accessed in accordance with the at least one customer preference. Such data in accordance with the at least one customer preference is then written to a storage device which is delivered to the customer.

In a further aspect of the invention, a method of providing customized information to a car rental customer is provided. First, the method includes receiving at least one preference from a car rental customer. Data in accordance with the at least one preference is accessed by use of a computer operating system. Data in accordance with the at least one preference is written to a storage device. For example, the storage device is an optical disk such as a compact disk. The storage device including the data in accordance with the at least one preference is then delivered to the car rental customer.

In accordance with specific aspects of the present method of providing information to a car rental customer, accessing data in accordance with the at least one customer preference includes accessing data from a plurality of content providers. Further, in such aspect, the plurality of content providers is selected from the group consisting of music providers, news providers, restaurant guide providers, entertainment providers, and sight seeing tour providers. In addition, the present method may further include the step of accessing and including advertising content on the storage device. For example, the advertising content may be selected based upon the at least one customer preference or upon customer demographics. Moreover, the instant method may include the step of storing the data in accordance with the at least one preference of the car rental customer so that such data may be accessed at a later time. For example, the data is stored in a format that may be accessed not only at later times, but at various locations.

In an additional aspect of the invention, an additional method of providing customized information to a car rental customer is disclosed. The exemplary method includes receiving at least one preference from a car rental customer. Data in accordance with the at least one preference is accessed by a computer operating system. Such data is then written to a storage device such as an optical disk. The data in accordance with the at least one preference of the car rental customer is then stored so that such data may be accessed at a later time. The storage device including data in accordance with the at least one preference is then delivered to the car rental customer. An aspect of this method also includes the step of accessing and including advertising content on the storage device.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method for providing customized information to a customer in accordance with an exemplary embodiment of the present invention;

FIG. 2 is a flow diagram illustrating a method for providing customized information to a customer in accordance with a further exemplary embodiment of the present invention, wherein the customer is a car rental customer;

FIG. 3 is a flow diagram illustrating a method for providing customized information to a customer in accordance with an additional exemplary embodiment of the present invention, wherein the method includes storing the information allowing data to be accessed at a later time;

FIG. 4 is a block diagram illustrating a system for providing customized information to a car rental customer in accordance with an exemplary embodiment of the present invention, wherein customized information may be accessed by additional car rental sites; and

FIG. 5 is a block diagram illustrating a system for providing customized information to a car rental customer in accordance with an additional exemplary embodiment of the present invention, wherein customized information may be requested from a customer via the Internet.

### DETAILED DESCRIPTION OF THE INVENTION

Reference will now be made in detail to the presently preferred embodiments of the invention, examples of which are illustrated in the accompanying drawings.

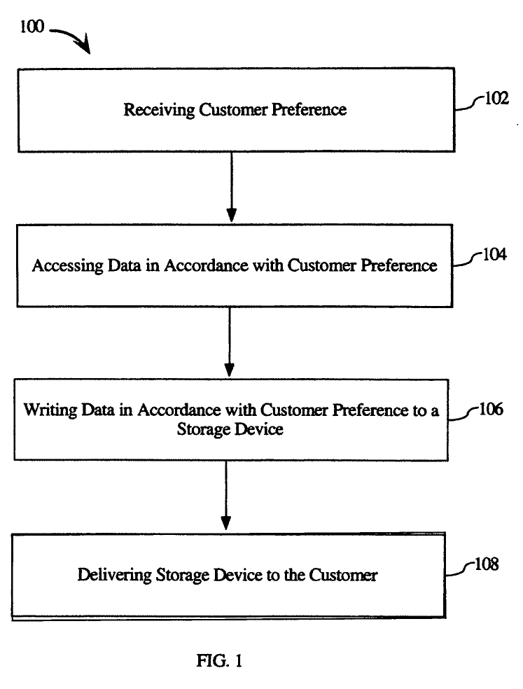

Referring to FIG. 1, a method 100 of providing customized information to a customer is disclosed. In an exemplary embodiment, the method 100 of providing customized information to a customer includes receiving one or more preferences from a customer 102. After receiving at least one customer preference 102, data is accessed in accordance with such preference 104. Such data in accordance with the at least one customer preference is written to a storage device 106 which is delivered to the customer 108.

An exemplary scenario in which the method 100 of providing customized information to a customer is the following. An air traveler arrives in their destination city and is in need of ground transportation during their stay. A car rental company or agency which is often located within walking distance of the airport is selected by the traveler. Upon arriving at the car rental company or agency, the traveler not only wishes to rent a car, but to obtain customized information which may be accessed by the traveler during transit. The traveler/car rental customer may select information or entertainment from a variety of sources including, but not limited to, local and national news providers, music providers, local information providers, and the like. For example, the car rental customer may request up-to-date news reports for they have not been able to access such information during their air travel. In the alternative, a customer may request information about local sites/points of interest which would allow the customer to either take a driving or walking tour of the city. Further, a customized music selection including music of a certain era (e.g., the 40's, 70's, or 80's) or genre (e.g., jazz, classical, pop, and the like) may be requested.

Once deciding on a type of information or entertainment, the customer relays such preference(s) to the car rental agency which, in turn, accesses the appropriate information 104. For example, the car rental agency employs a computer operating system to access the desired information. After accessing the desired information or entertainment, such data is then written to a storage device 106 such as an optical disk including a compact disk (CD) or a digital video disk (DVD) or the like. Such storage device is then delivered to the customer 108. In an embodiment, the storage device is a CD which may be played in the vehicle, a portable computer, in a portable compact disk player, and the like. Alternatively, the storage device is a DVD which may be played in the vehicle, a portable computer, a portable DVD player, and the like. It is contemplated that such method may be employed with other types of technology in addition to the optical disk such as a Moving Picture Experts Group Audio Layer 3 (MP3) file. Further, it is contemplated that additional storage devices may include a magnetic or semiconductor device (e.g., a thumb drive, flash memory, or similar device).

In additionally exemplary embodiments of the method 100, advertisements are included within the customized information. For example, advertisements may allow the fee associated with obtaining the customized information/entertainment to be partially or completely subsidized. Moreover, the type of advertisement included may vary depending upon customer demographics (e.g., income or occupation), customer preference, and the like.

In further exemplary embodiments, the step of storing the data in accordance with the at least one preference of the customer may be included so that such data may be accessed at a later time. For example, a frequent traveler may not wish to provide customer preferences each time they arrive at the car rental company or agency. Therefore, the storage of customer preferences which may be identified with a particular customer may allow the agency to provide the customer with such information at a later date. It is also contemplated that such information may be stored in a form which may be accessed by different car rental sites within the same agency or company.

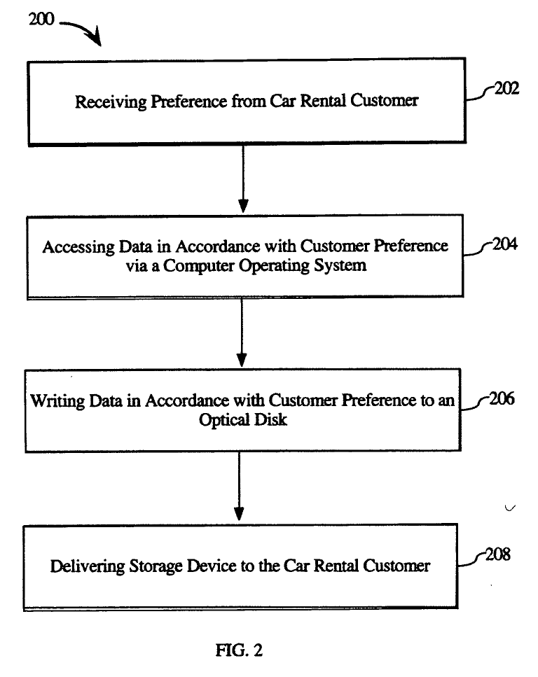

Referring to FIG. 2, a method 200 of providing customized information to a car rental customer is provided. First, the method 200 includes receiving at least one preference from a car rental customer 202. As mentioned previously, a customer may select music, news, local information (e.g. restaurant information, live entertainment information, and historical site information), and the like. After providing the car rental company or agency with at least one preference, data in accordance with the at least one preference is accessed by use of a computer operating system 204. Once accessed, data in accordance with the at least one preference is written to a storage device 206. As described above, various types of storage devices including an optical disk (such as a CD or a DVD), an MP3 file, a magnetic or semiconductor device (such as a thumb drive or a flash memory) or the like may be employed to store the information. The storage device including the data in accordance with the at least one preference is then delivered to the car rental customer 208. It is contemplated that the storage device may be given to the customer at the car rental agency counter or it may be installed in the vehicle by the car rental agency and obtained by the customer when the customer receives the car.

In accordance with additional embodiments of the method 200, the present method may further include accessing and including advertising content on the storage device. For example, the advertising content may be selected based upon the at least one customer preference or customer demographics. Moreover, the instant method may include the step of storing the data in accordance with the at least one preference of the car rental customer so that such data/preference may be accessed at a later time. For example, the data is stored in a format that may be accessed not only at later times, but at various locations.

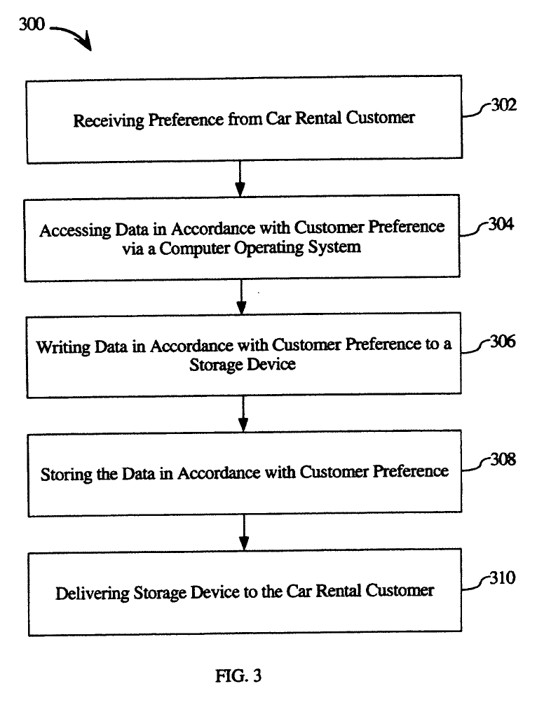

Referring to FIG. 3, an additional method 300 of providing customized information to a car rental customer is disclosed. The exemplary method 300 includes receiving at least one preference from a car rental customer 302. Data in accordance with the at least one preference is accessed by a computer operating system 304. Such data is then written to a storage device such as an optical disk 306. The data in accordance with the at least one preference of the car rental customer is then stored so that such data/preference may be accessed at a later time 308. For example, the data may be stored on a master computer data storage system located at the car rental headquarters. The storage device including data in accordance with the at least one preference is then delivered to the car rental customer 310. An embodiment of this method 300 also includes accessing and including advertising content on the storage device.

It is contemplated that the aforementioned methods of providing customized information to a customer may include constructing the storage device such as a CD or DVD to be time or use sensitive. For example, a customer may purchase a CD or DVD which was time sensitive in which the contents on the CD or DVD would disappear after a certain time period (e.g., the duration of the car rental) or number of uses for a certain price. In the alternative, a customer may purchase such device which is time or use independent for a price. In an embodiment, the cost of the time or use independent device is higher than that which is dependent upon time or use.

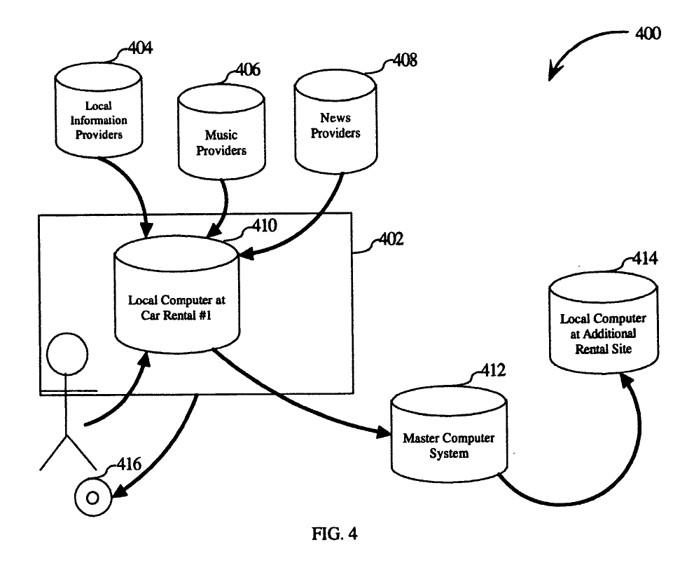

Referring to FIG. 4, a system for providing customized information to a car rental customer 400 in accordance with the present invention in which customized information may be accessed by additional car rental sites is provided. In an exemplary embodiment, system 400 includes a customer patronizing a first car rental site 402 located in their destination city. At the first car rental site 402, the car rental customer may acquire custom entertainment or information from a number of different providers including local information providers 404, music providers 406, and news providers 408. It is contemplated that additional providers such as literary providers, historical site information providers, and other specialized information providers may be accessed. For example, information such as Mother Goose is buried in this section of Boston or information about famous writers, artists and the like may be provided.

In an exemplary system, the customer provides the car rental agency with their preferences and then, the agency may utilize a computer operating system 410 to acquire the information from the various providers in accordance with the customer preference(s). After acquiring the data, the car rental agency provides the data to the customer on a storage device. In an embodiment, the storage device is an optical disk 416 such as a CD or DVD. It is contemplated that additional storage devices may employed such as a cassette tape, an MP3 file, or a magnetic or semiconductor device. In addition, the car rental agency stores the customer preference profile on a master system 412 such as a master computer system so that the profile may be accessed at a later time at the same car rental site or an additional car rental site 414. For example, the first car rental site 402 may transfer the information via a computer network to a data storage system maintained at a central location such as the car rental headquarters. Thus, such configuration allows customers to initialize their preference information at a later date as well as from an additional car rental site.

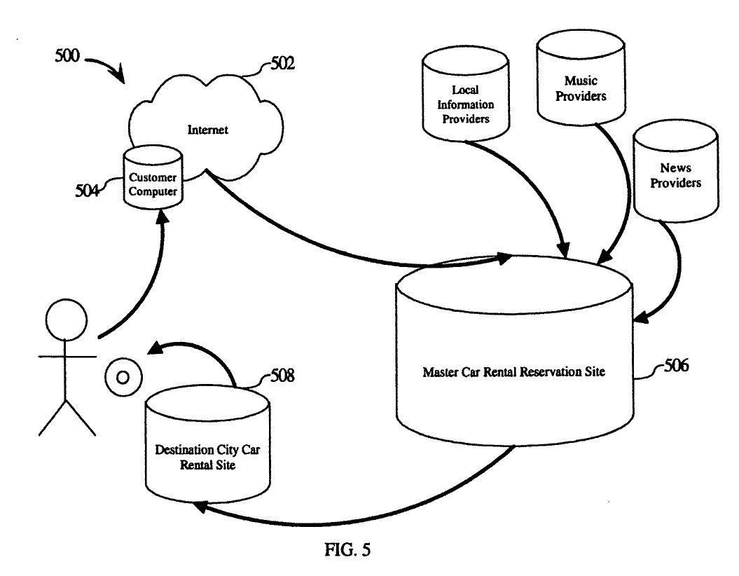

Referring to FIG. 5, a system for providing customized information to a car rental customer 500 in which customized information may be requested from a customer via the worldwide Internet is provided. As illustrated in FIG. 5, the system 500 allows a customer such as a car rental customer to request customized information via the internet 502. For example, a car rental customer often reserves a car prior to arriving at their destination city. Such a reservation is often placed by the customer via accessing a car rental specific website 506 or other travel provider website. It is contemplated that the customer may enter their preferences for entertainment or information at the time of placing the reservation or prior to their arrival. For example, the entry of a customer's preference(s) allows the master car rental agency 506 to prepare the customized information or entertainment prior to the customer's arrival at the destination city car rental site 508. Such design provides the customer with a time efficient manner of obtaining such services.

In an additional exemplary embodiment, Internet radio may be employed to deliver the customer's information. In an embodiment, a car rental agency or a customer may create customer preference listings. The customer preference listings may be maintained on a customized web page. The information in accordance with the customer preference listings may then be provided to the customer while in the vehicle by a wireless communication network including the Internet. Such configuration is advantageous for it allows the information (e.g., weather, news, and the like) to be up-dated in real time.

In an even further exemplary embodiment, the information in accordance with a customer preference may be loaded into a built-in memory unit disposed within the vehicle. Such information may be transferred to the built-in memory unit through a network such as a wireless network (e.g., the Internet). For example, while the vehicle is parked in the car rental agency parking lot, the customer information may be provided to the customer/car via a wireless network (e.g., WiFi, Bluetooth and the like) and saved in the built-in unit (e.g., audio/video, multi-media device). It is contemplated that a variety of wireless networks may be employed including networks which include ultra-wide band satellite access or standard mobile access. In accordance with this embodiment, the customer does not have to load the disk, cassette or the like into the audio device. Further, the information may be loaded into the built-in unit prior to the arrival of the customer.

Although the present disclosure associates the use of the present invention with a car rental agency, it is contemplated that the disclosed method and system may be applicable to a number of different ground and air transportation services. For example, such method and system may be employed by an airline carrier, train carrier, a bus line, and the like. Further, an individual who is traveling in their own vehicle may access the present services via the Internet or a local distributor.

It is to be noted that the foregoing described embodiments according to the present invention may be conveniently implemented using conventional general purpose digital computers programmed according to the teachings of the present specification, as may be apparent to those skilled in the computer art. Appropriate software coding may readily be prepared by skilled programmers based on the teachings of the present disclosure, as may be apparent to those skilled in the software art.

It is to be understood that the present invention may be conveniently implemented by use of a software package. Such a software package may be a computer program product which employs a computer-readable storage medium, including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of providing customized information to a customer, comprising:
receiving at least one customer preference;
accessing data in accordance with the at least one customer preference;
writing the data in accordance with the at least one customer preference to a storage device; and
delivering the storage device including data in accordance with the at least one customer preference to the customer.

2. The method of providing customized information to a customer as claimed in claim 1, wherein the customer is a rental car customer.

3. The method of providing customized information to a customer as claimed in claim 1, wherein the accessing data in accordance with the at least one customer preference includes accessing data from a plurality of content providers.

4. The method of providing customized information to a customer as claimed in claim 3, wherein the plurality of content providers are selected from the group consisting of music providers, entertainment information providers, news providers, restaurant guide providers, entertainment providers, sports information providers, historical information providers, literary information providers, and sight seeing tour providers.

5. The method of providing customized information to a customer as claimed in claim 1, wherein the storage device is a selected from the group consisting of a compact disk, digital video disk, and cassette tape.

6. The method of providing customized information to a customer as claimed in claim 1, further comprising accessing and including advertising content on the storage device.

7. The method of providing customized information to a customer as claimed in claim 6, wherein advertising content is selected based upon at least one of the at least one customer preference or upon customer demographics.

8. The method of providing customized information to a customer as claimed in claim 1, wherein the receiving at least one preference from a customer is by use of the Internet.

9. The method of providing customized information to a customer as claimed in claim 1, wherein at least one of accessing data in accordance with the at least one preference or delivering the storage device including data in accordance with the at least one customer preference to the customer includes use of a communication network.

10. The method of providing customized information to a customer as claimed in claim 1, further comprising storing the preference in accordance with the at least one preference of the customer so that such data may be accessed at a later time.

11. A computer-readable medium having computer-executable instructions for performing a method of providing customized information to a car rental customer, the method comprising:
receiving at least one preference from a car rental customer;
accessing data in accordance with the at least one preference, accessing data is performed by a computer operating system;
writing the data in accordance with the at least one preference to a storage device; and
delivering the storage device including data in accordance with the at least one preference to the car rental customer.

12. The computer-readable medium as claimed in claim 11, wherein the method of accessing data in accordance with the at least one customer preference includes accessing data from a plurality of content providers.

13. The computer-readable medium as claimed in claim 12, wherein the plurality of content providers are selected from the group consisting of music providers, news providers, restaurant guide providers, entertainment providers, literary providers, and sight seeing tour providers.

14. The computer-readable medium as claimed in claim 11, wherein the storage device is selected from the group consisting of a compact disk, digital video disk, and cassette tape.

15. The computer-readable medium as claimed in claim 11, wherein the method further comprises accessing and including advertising content on the storage device.

16. The computer-readable medium as claimed in claim 15, wherein advertising content is selected based upon the at least one customer preference.

17. The computer-readable medium as claimed in claim 15, wherein the advertising content is selected based upon customer demographics.

18. The computer-readable medium as claimed in claim 10, wherein the method further comprises storing the preference so that the preference may be accessed at a later time.

19. The computer-readable medium as claimed in claim 18, wherein the preference is stored in a format that may be accessed at various locations.

20. The computer-readable medium as claimed in claim 10, wherein the method of delivering the storage device including data in accordance with the at least one preference to the car rental customer includes use of a communication network.
